(19) United States
(12) Patent Application Publication
(10) Pub. No.: US 2025/0305630 A1
(43) Pub. Date: Oct. 2, 2025

(54) ELECTROMAGNETIC VALVE

(71) Applicant: TOYOTA JIDOSHA KABUSHIKI KAISHA, Toyota-shi (JP)

(72) Inventors: Mina TACHIBANA, Toyota-shi (JP); Yuki SUZUKI, Kariya-shi (JP); Tomihisa TSUCHIYA, Toyota-shi (JP)

(73) Assignee: TOYOTA JIDOSHA KABUSHIKI KAISHA, Toyota-shi (JP)

(21) Appl. No.: 19/069,318

(22) Filed: Mar. 4, 2025

(30) Foreign Application Priority Data
Apr. 1, 2024 (JP) 2024-059182

(51) Int. Cl. F16N 7/36; F02M 51/06; F02M 63/00; F16K 31/06

(52) U.S. Cl. CPC F16N 7/36; F02M 51/061; F02M 63/0001; F16K 31/0655; F16N 2210/04; F16N 2280/02

(57) ABSTRACT

An electromagnetic valve is provided in a fuel supply system of an internal combustion engine. The electromagnetic valve includes an oil chamber from which lubricating oil is supplied to an interior of the electromagnetic valve.

### CROSS-REFERENCE TO RELATED APPLICATIONS

This application is based upon and claims the benefit of priority from Japanese Patent Application No. 2024-059182, filed on Apr. 1, 2024, the entire contents of which are incorporated herein by reference.

### BACKGROUND

### 1. Field

The present disclosure relates to an electromagnetic valve.

### 2. Description of Related Art

For example, an internal combustion engine disclosed in Japanese Laid-Open Patent Publication No. 2022-182969 reduces the pressure of gas fuel stored in a tank before supplying the gas fuel to fuel injection valves.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electromagnetic valve is provided in a fuel supply system of an internal combustion engine. The electromagnetic valve includes an oil chamber from which lubricating oil is supplied to an interior of the electromagnetic valve.

This electromagnetic valve suppresses wear of the electromagnetic valve due to selective opening and closing.

Other features and aspects will be apparent from the following detailed description, the drawings, and the claims.

### BRIEF DESCRIPTION OF THE DRAWINGS

FIG. 1 is a schematic diagram of an internal combustion engine in which an electromagnetic valve according to an embodiment is employed, a fuel supply system, and a controller.

FIG. 2 is a timing diagram showing a fuel pressure control according to the embodiment, in which part (a) shows changes in fuel pressure, and part (b) shows an operating state of a second shut-off valve.

FIG. 3 is a cross-sectional view showing the structure of the second shut-off valve according to the embodiment.

FIG. 4 is a diagram showing a lubrication path in the second shut-off valve according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

In the internal combustion engine as described in the background art, the following control may be performed as the fuel pressure reduction control.

That is, a fuel passage connecting a tank for storing fuel and a fuel injection valve for supplying fuel to a cylinder is provided with an electromagnetic valve for opening and closing the fuel passage. Then, an allowable upper limit value and an allowable lower limit value are set for the target fuel pressure. If fuel injection from the fuel injection valve is performed in a state where the electromagnetic valve is closed, fuel flows out from the fuel passage downstream of the electromagnetic valve, so the fuel pressure downstream of the electromagnetic valve falls. When the downstream fuel pressure reaches a lower limit value, the electromagnetic valve is driven to open. Since the fuel is supplied to the fuel passage downstream of the electromagnetic valve by the valve-opening drive of the electromagnetic valve, the fuel pressure downstream of the electromagnetic valve increases. When the downstream fuel pressure reaches an upper limit value, the electromagnetic valve is driven to close. By repeatedly driving the electromagnetic valve to open and close in this manner, the pressure of the fuel downstream of the electromagnetic valve, which is the pressure of the fuel supplied to the fuel injection valve, is adjusted to a fuel pressure within a prescribed range between an upper limit and a lower limit.

When the selective opening and closing of the electromagnetic valve is repeatedly performed, abrasion may progress in a sliding portion of the electromagnetic valve in accordance with the opening and closing. Even in a case where the fuel pressure control is not performed, if selective opening and closing of the electromagnetic valve is repeatedly performed for a long period of time, wear may progress in the sliding portion of the electromagnetic valve.

Therefore, in the electromagnetic valve, it is desired to suppress wear caused by selective opening and closing.

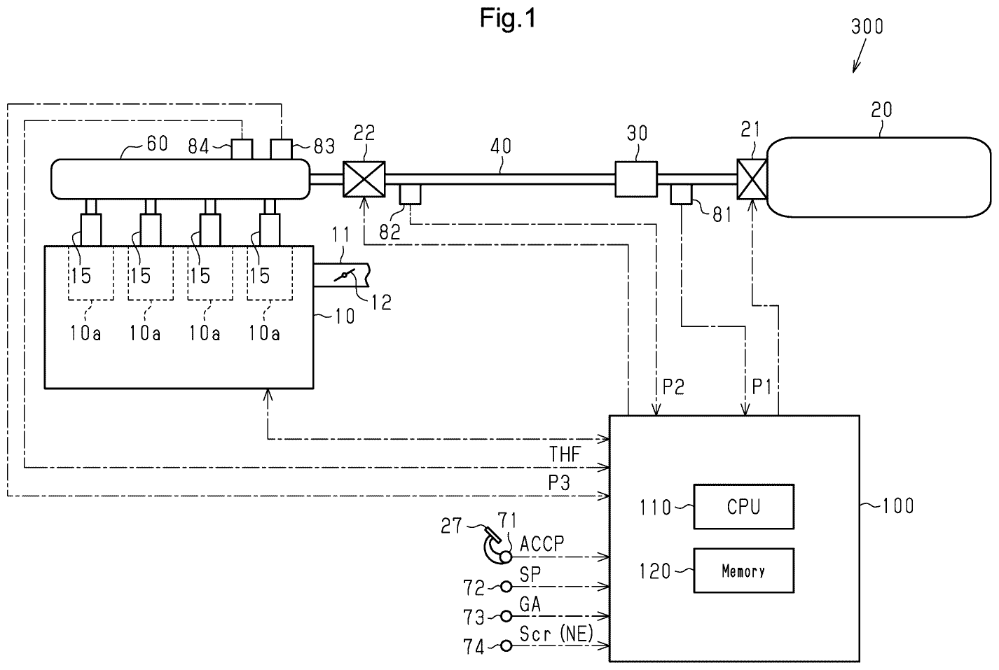

Hereinafter, an embodiment of an electromagnetic valve will be described with reference to FIGS. 1 to 4.

### Internal Combustion Engine, Fuel Supply Device, and Controller

An internal combustion engine 10 shown in FIG. 1 is mounted on a vehicle and uses hydrogen gas, which is a gas fuel, as a fuel.

A throttle valve 12 that adjusts an intake air amount is provided in an intake passage 11 of the internal combustion engine 10.

The fuel supply device 300 provided in the internal combustion engine 10 includes multiple fuel injection valves 15, a tank 20, a fuel pipe 40, a first shut-off valve 21, a second shut-off valve 22, a pressure reducing valve 30, and a delivery pipe 60.

The fuel injection valves 15 supply fuel to cylinders 10a of the internal combustion engine 10.

The tank 20 stores hydrogen gas, which is gas fuel, in a high-pressure compressed state.

The fuel pipe 40 connects the tank 20 and the delivery pipe 60.

The fuel injection valves 15 are connected to the delivery pipe 60. The fuel pipe 40 and the delivery pipe 60 are a fuel passage connecting the tank 20 and the fuel injection valves 15. The hydrogen gas stored in the tank 20 is supplied to the fuel injection valves 15 via the fuel pipe 40 and the delivery pipe 60.

The first shut-off valve 21, the pressure reducing valve 30, and the second shut-off valve 22 are arranged in the fuel pipe 40 in this order in a direction of fuel flow.

The first shut-off valve 21 is an electromagnetic valve arranged near an outlet of the tank 20. When the first shut-off valve 21 is open, fuel is supplied from the tank 20 to the fuel pipe 40. When the first shut-off valve 21 is closed, the supply of fuel from the tank 20 to the fuel pipe 40 is stopped.

The pressure reducing valve 30 reduces the fuel pressure of the high-pressure hydrogen gas stored in the tank 20 to a prescribed pressure (for example, approximately 4 MPa) and supplies the hydrogen gas to the fuel injection valves 15.

The second shut-off valve 22 is an electromagnetic valve provided in the fuel supply system of the internal combustion engine 10, and is disposed in the vicinity of the delivery pipe 60 in the fuel pipe 40. When the second shut-off valve 22 is open due to energization, fuel is supplied to the delivery pipe 60. When the second shut-off valve 22 is closed due to the de-energization, the supply of fuel to the delivery pipe 60 is stopped.

The first shut-off valve 21 and the second shut-off valve 22 are closed while the operation of the internal combustion engine 10 is stopped. On the other hand, the first shut-off valve 21 and the second shut-off valve 22 are basically open during operation of the internal combustion engine 10.

A first pressure sensor 81 is provided in the fuel pipe 40 between the first shut-off valve 21 and the pressure reducing valve 30. The first pressure sensor 81 detects a first pressure P1, which is a fuel pressure in the fuel pipe 40 between the first shut-off valve 21 and the pressure reducing valve 30.

A second pressure sensor 82 provided in the fuel pipe 40 between the pressure reducing valve 30 and the second shut-off valve 22. The second pressure sensor 82 detects a second pressure P2, which is a fuel pressure in the fuel pipe 40 between the pressure reducing valve 30 and the second shut-off valve 22.

A third pressure sensor 83 provided in the delivery pipe 60 detects a third pressure P3, which is a fuel pressure in the delivery pipe 60. A temperature sensor 84 provided in the delivery pipe 60 detects a fuel temperature THE, which is a temperature of the fuel in the delivery pipe 60.

The controller 100 performs various types of control such as fuel injection of the internal combustion engine 10 by controlling various control targets such as the throttle valve 12, the fuel injection valves 15, the first shut-off valve 21, and the second shut-off valve 22. The controller 100 includes a memory 120 constituted by storage devices such as a CPU 110, a ROM, and a RAM. The controller 100 performs various controls when the CPU 110 executes a program stored in the memory 120.

The controller 100 refers to various values used to control the internal combustion engine 10. For example, the controller 100 refers to detection values of the first pressure sensor 81, the second pressure sensor 82, the third pressure sensor 83, and the temperature sensor 84. Further, the controller 100 refers to a detection signal of an accelerator position sensor 71 that detects an accelerator operation amount ACCP that is an operation amount of an accelerator pedal 27 operated by a driver of the vehicle on which the internal combustion engine 10 is mounted. In addition, the controller 100 refers to a detection signal of a speed sensor 72 that detects a vehicle speed SP of a vehicle on which the internal combustion engine 10 is mounted. Further, the controller 100 refers to a detection signal of an air flow meter 73 that detects an intake air amount GA of the internal combustion engine 10, and a detection signal Scr of a crank angle sensor 74 that detects a rotation angle of a crankshaft of the internal combustion engine 10.

The controller 100 calculates an engine rotation speed NE based on a detection signal Scr of the crank angle sensor 74. In addition, the controller 100 calculates an engine load factor KL based on the engine rotation speed NE and the intake air amount GA. The engine load factor KL represents the ratio of the current cylinder inflow air amount to the cylinder inflow air amount at the time of steady operation of the internal combustion engine 10 in a full load state at the current engine rotation speed NE. The cylinder inflow air amount is the amount of air that flows into each cylinder in the intake stroke.

Hydrogen gas, which serves as the engine fuel, has a wider range of combustible air-fuel mixtures compared to gasoline and can burn even with a relatively lean air-fuel mixture. Therefore, the controller 100 adjusts the output of the internal combustion engine 10 through the following combustion control.

That is, the controller 100 calculates a required output Pe, which is a required value of the engine output of the internal combustion engine 10, based on the accelerator operation amount ACCP and the like. The controller 100 sets the required injection amount Qd based on the required output Pe. The required injection amount Qd is a target value of the fuel injected from one fuel injection valve 15 in one combustion cycle. Based on the target air-fuel ratio AFt and the required injection amount Qd, the controller 100 calculates a required air amount GAd that is a target value of the intake air amount required for obtaining the target air-fuel ratio AFt. The target air-fuel ratio AFt of the present embodiment is a lean air-fuel ratio such as an excess air ratio λ=2.5 to 3.0, for example. Then, the controller 100 controls the fuel injection valves 15 such that an amount of fuel corresponding to the required injection amount Qd is injected. Further, the controller 100 controls the opening degree of the throttle valve 12 so that an amount of air corresponding to the required air amount GAd is introduced into the cylinder. In this way, in the internal combustion engine 10, the output adjustment is performed by changing the air-fuel ratio of the air-fuel mixture through the adjustment of the fuel injection amount and the intake air amount.

### Fuel Pressure Control

The controller 100 executes fuel pressure control for controlling the pressure of the fuel supplied to the fuel injection valves 15, that is, the fuel pressure in the fuel passage connected to the downstream side of the second shut-off valve 22 in the flow direction of the fuel in the fuel passage. This fuel pressure control includes repeatedly performing selective opening and closing of the second shut-off valve 22 so that the fuel pressure in the fuel passage connected downstream of the second shut-off valve 22 becomes a pressure within a control range CR defined by a prescribed upper limit value PtU and a prescribed lower limit value PtL. A target pressure Pt in the fuel pressure control is lower than the second pressure P2, which is the fuel pressure reduced by the pressure reducing valve 30, and is set in advance. For example, the target pressure Pt is about 1 Mpa. The upper limit value PtU is set to an upper limit value of the fuel pressure allowable with respect to the target pressure Pt. The lower limit value PtL is set to a lower limit value of the fuel pressure allowable with respect to the target pressure Pt.

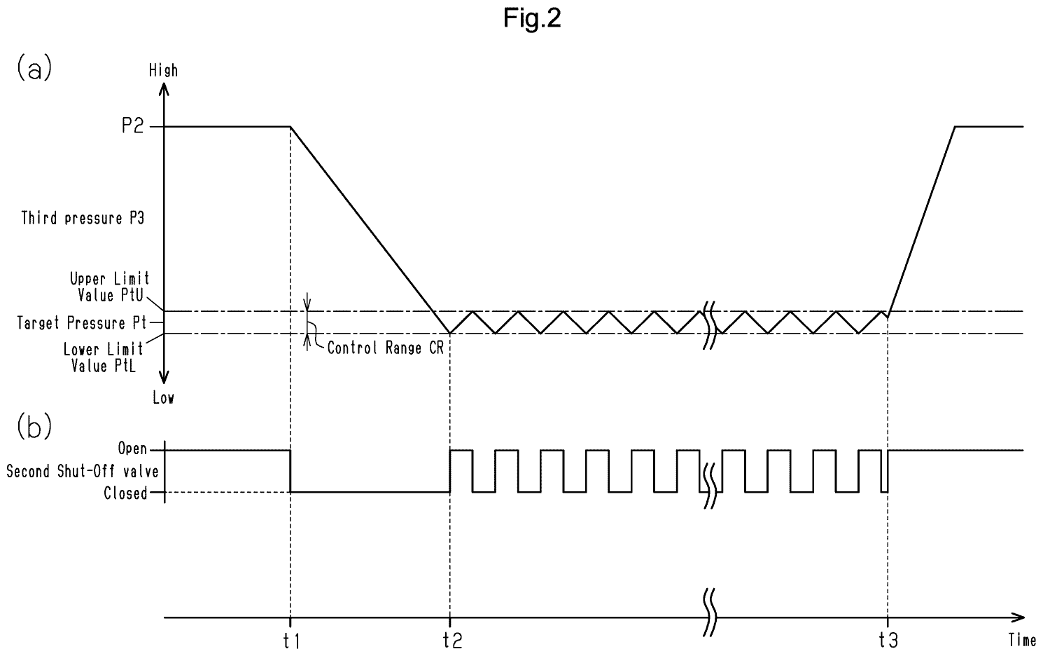

FIG. 2 shows an example of the fuel pressure control. Part (a) of FIG. 2 shows changes in the third pressure P3. Part (b) of FIG. 2 shows the operating state of the second shut-off valve 22. The fuel pressure control is executed, for example, when the operation state of the internal combustion engine 10 shifts to an idle operation state.

Before a point in time t1, the hybrid vehicle is traveling normally, and the second shut-off valve 22 is maintained in the open state. The third pressure P3 is equal to the second pressure P2 that has been reduced by the pressure reducing valve 30.

At the point in time t1, when the internal combustion engine 10 is required to be operated at idle, the second shut-off valve 22 is closed and the closed state is maintained. While the second shut-off valve 22 is closed, the amount of fuel in the delivery pipe 60 decreases each time fuel is injected from the fuel injection valves 15. Thus, the third pressure

P3 gradually decreases.

At a point in time t2, the second shut-off valve 22 is opened when the third pressure P3 reaches the lower limit value PtL. Since the fuel is supplied to the fuel passage downstream of the second shut-off valve 22 by the opening of the second shut-off valve 22, the fuel pressure downstream of the second shut-off valve 22 increases. The second shut-off valve 22 is closed when the third pressure P3 reaches the upper limit value PtU. By repeatedly performing such selective opening and closing of the second shut-off valve 22, the pressure of the fuel downstream of the second shut-off valve 22 and supplied to the fuel injection valves 15 is adjusted to a pressure within the prescribed control range CR defined by the upper limit value PtU and the lower limit value PtL.

In this way, when the required injection amount Qd decreases as in the idle operation, the fuel pressure control is performed to maintain the third pressure P3 at a low level. As a result, a small amount of fuel is accurately injected from the fuel injection valves 15.

At a point in time t3, for example, when the operation state of the internal combustion engine 10 shifts to a state in which the engine load is higher than that in the idle operation state and the execution request of the fuel pressure control is not issued, the second shut-off valve 22 is maintained in the open state. While the second shut-off valve 22 is open, fuel is supplied from the tank 20 to the delivery pipe 60, so the third pressure P3 gradually increases toward the second pressure P2.

### Structure of the Second Shut-Off Valve

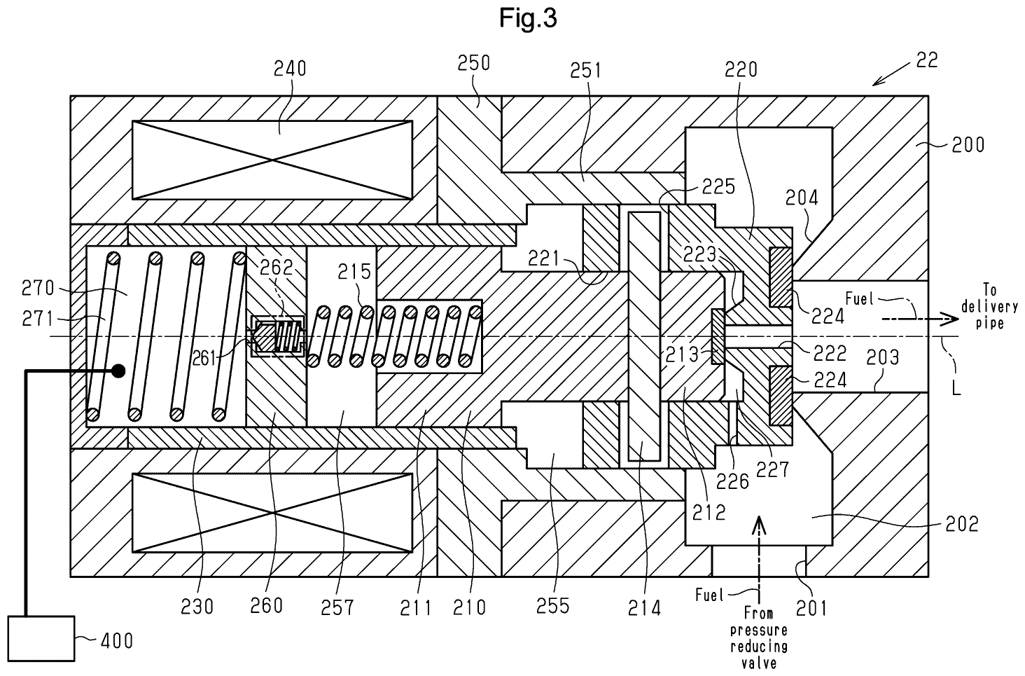

FIG. 3 shows the structure of the second shut-off valve 22. Hereinafter, a direction along the central axis L of the plunger 211 included in the second shut-off valve 22 is referred to as an axial direction. A direction orthogonal to the axial direction is referred to as a radial direction.

The second shut-off valve 22 includes a housing 200, a stator 230, an electromagnetic coil 240, a first valve 210, a holder 250, a second valve 220, an oil chamber 270, and the like.

The housing 200 includes an inlet port 201 to which the fuel pipe 40 connected to the pressure reducing valve 30 is connected, and an outlet port 203 to which the fuel pipe 40 connected to the delivery pipe 60 is connected.

The inlet port 201 and the outlet port 203 are connected to each other via a first chamber 202 which is a space formed in the housing 200.

The stator 230 has a tubular shape and is provided in the housing 200.

The electromagnetic coil 240 is provided on the outer side of the stator 230.

The first valve 210 includes a plunger 211, which moves in the axial direction in the stator 230, and a first seal member 213, which opens and closes a first fuel passage 222 through movement of the plunger 211.

One end of the plunger 211 is a projecting portion 212 protruding from the stator 230. The first seal member 213 is provided at the distal end of the projecting portion 212. The projecting portion 212 includes a pin 214 extending in the radial direction. Both ends of the pin 214 protrude from the outer peripheral surface of the projecting portion 212.

The holder 250 has a tubular portion 251 coaxial with the central axis L. The inner peripheral surface of the tubular portion 251 is opposed to and spaced apart from the outer peripheral surface of the projecting portion 212.

The second valve 220 is slidably accommodated in the inner peripheral surface of the tubular portion 251. The second valve 220 has a hole 221 in which the outer peripheral surface of the projecting portion 212 of the first valve 210 slides. The second valve 220 is formed with a long hole 225 into which the pin 214 is inserted and which allows the pin 214 to move in the axial direction.

The first fuel passage 222 extending in the axial direction is formed at the distal end of the second valve 220. The first fuel passage 222 is connected to the outlet port 203 constituting the second fuel passage. The outlet port 203 is a fuel passage having a larger cross-sectional flow area than the first fuel passage 222.

A second seal member 224 for opening and closing the outlet port 203 is provided at the distal end of the second valve 220. More specifically, the second seal member 224 opens and closes a second valve seat 204 provided at one end of the outlet port 203.

A first valve seat 223 protruding toward the projecting portion 212 is formed at the distal end of the second valve 220 where the first fuel passage 222 is formed. When the first valve seat 223 is opened and closed by the first seal member 213, the first fuel passage 222 is opened and closed.

In the hole 221, a space surrounded by a wall surface around the first valve seat 223 and a distal end surface of the projecting portion 212 serves as a back pressure chamber 227 on which a pressure for biasing the second valve 220 in the valve closing direction acts. The back pressure chamber 227 is connected to the first chamber 202 via a connecting passage 226.

A second chamber 255, which is a space for securing a stroke amount of the second valve 220 in the axial direction, is formed on the inner peripheral surface side of the tubular portion 251 of the holder 250.

An oil chamber 270 from which lubricating oil is supplied to the interior of the second shut-off valve 22 is provided inside the stator 230 at an end portion on the side opposite to the side where the plunger 211 is inserted. Lubricating oil is supplied to the oil chamber 270 from a lubricating oil circuit 400 included in the internal combustion engine 10. The oil chamber 270 is kept airtight by a piston 260 sliding on the inner peripheral surface of the stator 230.

The piston 260 is disposed in the stator 230 at a position axially spaced apart from the plunger 211. A third chamber 257, which is a space, is defined between the piston 260 and the plunger 211.

The piston 260 is provided with a connecting hole 261 that allows fluid communication between the oil chamber 270 and the third chamber 257. The connecting hole 261 is provided with a check valve 262, which allows lubricating oil to be supplied from the oil chamber 270 to the third chamber 257 when the pressure in the oil chamber 270 becomes higher than or equal to a prescribed pressure.

The oil chamber 270 is provided with a spring 271 for urging the piston 260 toward the plunger 211. A spring 215 is provided between the piston 260 and the plunger 211 to bias the piston 260 and the plunger 211 in directions away from each other.

Opening and Closing Operation of the Second Shut-Off Valve

When the electromagnetic coil 240 is energized, the plunger 211 is drawn into the stator 230. As a result, the first valve 210 moves in a direction in which the first seal member 213 separates from the first valve seat 223, whereby the first valve 210 is opened. When the first seal member 213 is separated from the first valve seat 223, the fuel flowing in from the inlet port 201 flows into the outlet port 203 via the first chamber 202, the connecting passage 226, the back pressure chamber 227, and the first fuel passage 222.

When the first valve 210 moves in the direction in which the first seal member 213 separates from the first valve seat 223, the pin 214 of the first valve 210 comes into contact with the wall surface in the axial direction of the long hole 225 of the second valve 220. Therefore, a force Fop acting in the same direction as the moving direction of the first valve 210 is applied to the second valve 220.

When the first valve 210 is opened, the back pressure chamber 227 and the outlet port 203 are connected to each other, so that the pressure difference between the inside of the back pressure chamber 227 and the inside of the outlet port 203 decreases. Therefore, the force Fcl that urges the second valve 220 in the valve closing direction decreases. The force Fcl includes a force generated by a pressure difference between the inside of the back pressure chamber 227 and the inside of the outlet port 203 and the biasing force of the spring 215.

Then, when the force Fop becomes larger than the force Fcl, the second valve 220 moves in a direction in which the second seal member 224 is separated from the second valve seat 204, whereby the opening operation of the second valve 220 is performed. When the second seal member 224 is separated from the second valve seat 204, the fuel flowing in from the inlet port 201 flows into the outlet port 203 mainly via the first chamber 202.

The fuel flowing into the outlet port 203 is delivered to the fuel injection valves 15 via the fuel pipe 40 and the delivery pipe 60.

When the energization of the electromagnetic coil 240 is stopped, the first valve 210 moves in a direction in which the first seal member 213 comes into contact with the first valve seat 223 due to the biasing force of the spring 215 or the like. Thus, the closing operation of the first valve 210 is performed.

When the first seal member 213 abuts against the first valve seat 223, the biasing force of the spring 215 acts on the second valve 220. Therefore, the second valve 220 moves in a direction in which the second seal member 224 comes into contact with the second valve seat 204. Thus, the closing operation of the second valve 220 is performed.

In this way, in the second shut-off valve 22, the opening of the second valve 220 that opens and closes the outlet port 203 having a larger cross-sectional flow area than the first fuel passage 222 is performed by using the pressure of the back pressure chamber 227. Therefore, the magnetic force required for opening the second valve 220 can be reduced as compared with the case where the second valve 220 is opened by directly using the magnetic force of the electromagnetic coil. Therefore, the electromagnetic coil 240 can be miniaturized.

Further, in the second shut-off valve 22, the first valve 210 is used to regulate the fuel at a small flow rate. Therefore, the fuel pressure control described above is performed by selectively opening and closing the first valve 210. Further, in an operating state where the engine load is higher than in the idle operating state, the second valve 220 is opened.

### Operation of the Present Embodiment

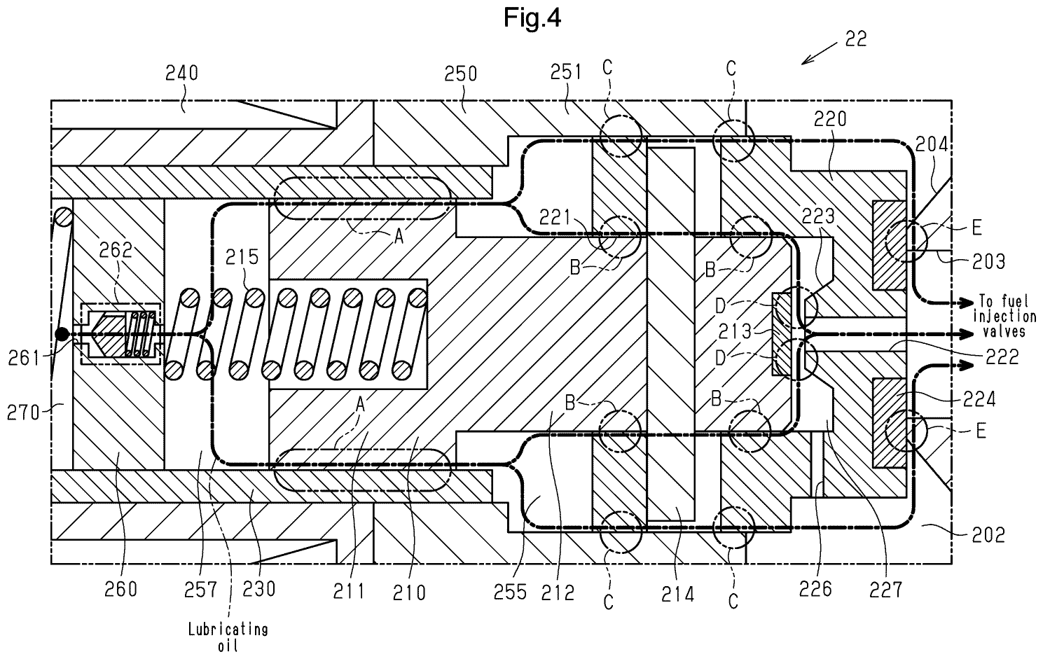

FIG. 4 shows a lubrication path in the second shut-off valve 22.

When an opening operation of the first valve 210 is performed by the first valve 210 moving in a direction in which the first seal member 213 separates from the first valve seat 223, the piston 260 moves in a direction toward the oil chamber 270 due to the biasing force of the spring 215. Since the volume of the oil chamber 270 is reduced through movement of the piston 260, the pressure in the oil chamber 270 increases. When the pressure in the oil chamber 270 becomes higher than or equal to the prescribed pressure, the check valve 262 is opened, so that the supply of the lubricating oil from the oil chamber 270 to the third chamber 257 is allowed. Therefore, the lubricating oil is allowed to be supplied from the oil chamber 270 into the stator 230.

The lubricating oil supplied into the stator 230 flows into a sliding portion A where the outer peripheral surface of the plunger 211 slides on the inner peripheral surface of the stator 230. The lubricating oil flowing into the sliding portion A lubricates the sliding portion A. The lubricating oil that has lubricated the sliding portion A flows into the second chamber 255.

The lubricating oil that has flowed into the second chamber 255 flows into the sliding portion B where the outer peripheral surface of the projecting portion 212 of the first valve 210 and the hole 221 of the second valve 220 slide. The lubricating oil flowing into the sliding portion B lubricates the sliding portion B. The lubricating oil that has lubricated the sliding portion B flows into the back pressure chamber 227.

The lubricating oil that has flowed into the back pressure chamber 227 flows into the first fuel passage 222 together with the fuel. The seal portion D of the first valve 210 constituted by the first seal member 213 and the first valve seat 223 is lubricated by the lubricating oil mixed with the fuel.

The lubricating oil that has flowed into the second chamber 255 flows into the sliding portion C where the outer peripheral surface of the second valve 220 and the inner peripheral surface of the tubular portion 251 of the holder 250 slide. The lubricating oil flowing into the sliding portion C lubricates the sliding portion C. The lubricating oil that has lubricated the sliding portion C flows into the first chamber 202.

The lubricating oil flowing into the first chamber 202 flows into the seal portion E formed by the second seal member 224 and the second valve seat 204. The seal portion E of the second valve 220 constituted by the second seal member 224 and the second valve seat 204 is lubricated by the lubricating oil that has flowed into the seal portion E.

The fuel flowing into the first fuel passage 222 is delivered to the fuel injection valves 15 via the outlet port 203, the fuel pipe 40, and the delivery pipe 60. The fuel delivered to the fuel injection valves 15 contains lubricating oil. Therefore, the sliding portions of the fuel injection valves 15 and the contact portions where the needle and the valve seat of the fuel injection valves 15 are in contact with each other are lubricated by the lubricating oil contained in the fuel.

### Advantages of the Present Embodiment

(1) The second shut-off valve 22 provided in the fuel supply system of the internal combustion engine 10 includes the oil chamber 270, from which the lubricating oil is supplied to the inside of the second shut-off valve 22. Therefore, since the lubricating oil is supplied from the oil chamber 270 to the inside of the second shut-off valve 22, it is possible to suppress the wear of the second shut-off valve 22 due to the opening and closing operation.

(2) More specifically, the second shut-off valve 22 includes a housing 200, a stator 230, an electromagnetic coil 240 provided on the outer side of the stator 230, and a first valve 210.

The first valve 210 has a plunger 211 which moves in the stator 230, and a first seal member 213 which opens and closes the first fuel passage 222 through movement of the plunger 211.

In the stator 230, the oil chamber 270 and a piston 260 that reduces the volume of the oil chamber 270 through the opening operation of the first valve 210 are provided.

The piston 260 includes a check valve 262 that allows the lubricating oil to be supplied from the oil chamber 270 into the stator 230 when the pressure in the oil chamber 270 becomes higher than or equal to the prescribed pressure.

The second shut-off valve 22 includes an outlet port 203, which is a fuel passage having a cross-sectional flow area larger than that of the first fuel passage 222, is connected to the first fuel passage 222. The outlet port 203 is a second fuel passage, which is opened and closed by the second seal member 224.

The second shut-off valve 22 includes a holder 250 provided in the housing 200 and a second valve 220. The second valve 220 is accommodated to be slidable on the inner peripheral surface of the tubular portion 251 of the holder 250, and includes the second seal member 224. The second valve 220 includes a hole 221 on which the outer peripheral surface of the projecting portion 212 of the first valve 210 slides.

Accordingly, when the volume of the oil chamber 270 is reduced through the opening operation of the first valve 210, the pressure in the oil chamber 270 increases. When the pressure in the oil chamber 270 becomes higher than or equal to the prescribed pressure, the supply of the lubricating oil from the oil chamber 270 into the stator 230 is allowed. The lubricating oil supplied into the stator 230 lubricates the plunger 211 of the first valve 210 that moves in the stator 230, the first seal member 213 of the first valve 210, and the first valve seat 223 against which the first seal member 213 abuts. Therefore, wear of the first valve 210 and the seal portion of the first valve 210 can be suppressed.

In addition, since the lubricating oil supplied into the stator 230 is supplied to the outer peripheral surface of the first valve 210 which moves in the stator 230, the lubricating oil is also supplied to the hole 221 of the second valve 220 in which the outer peripheral surface of the first valve 210 slides. Therefore, the sliding portion between the first valve 210 and the second valve 220 is lubricated. Further, since the lubricating oil supplied to the outer peripheral surface of the first valve 210 is also supplied to the inner peripheral surface of the holder 250, the sliding portion between the holder 250 and the second valve 220 is lubricated. The lubricating oil supplied to the sliding portion between the holder 250 and the second valve 220 lubricates the second seal member 224 of the second valve 220 and the second valve seat 204 with which the second seal member 224 is in contact. Therefore, wear of the second valve 220 and the seal portion of the second valve 220 can also be suppressed.

(3) The lubricating oil that has lubricated the first seal member 213 and the first valve seat 223 is mixed with the fuel of the internal combustion engine 10 because the first valve 210 is open. Therefore, the fuel injection valves 15 connected to the most downstream side in the fuel supply system of the internal combustion engine 10 are supplied with lubricating oil together with fuel. Therefore, it is also possible to suppress wear of the sliding portion of the fuel injection valves 15 and wear of the contact portion where the needles and the valve seats of the fuel injection valves 15 come into contact with each other.

(4) When performing fuel pressure control, in which the pressure of fuel is adjusted by repeatedly opening and closing the electromagnetic valve, the number of times the electromagnetic valve opens and closes increases compared to when fuel pressure control is not performed. Therefore, wear of the electromagnetic valve due to the opening/closing operation is likely to progress. In this regard, according to this configuration, since the above-described second shut-off valve 22 is applied to such fuel pressure control, it is possible to suppress wear of the second shut-off valve 22, which is an electromagnetic valve, even when fuel pressure control in which wear of the electromagnetic valve is likely to progress is performed.

(5) The fuel of the internal combustion engine 10 is gas fuel. Unlike liquid fuels such as gasoline, gas fuels have poor lubricity. Therefore, in the second shut-off valve 22 and the fuel injection valves 15 that repeat opening and closing, wear due to sliding is likely to progress. In this regard, according to the present embodiment, as described above, the second shut-off valve 22 and the fuel injection valves 15 are lubricated by the lubricating oil supplied to the oil chamber 270. Therefore, it is possible to suppress wear of the second shut- off valve 22 and the fuel injection valves 15 provided in the fuel system of the internal combustion engine 10 using the gas fuel.

### Modifications

The above-described embodiment may be modified as follows. The above-described embodiment and the following modifications can be combined as long as the combined modifications remain technically consistent with each other.

The second shut-off valve 22 may not include the second valve 220. In this case, the second valve seat 204 may be opened and closed by the first valve 210.

The second shut-off valve 22 is an electromagnetic valve applied to the fuel pressure control described above, but may not be applied to such fuel pressure control. For example, the second shut-off valve 22 may be controlled so as to be held in an open state during engine operation, while being held in a closed state while engine operation is stopped.

The piston 260 has a check valve 262. In addition, the piston 260 may have a through hole having a small diameter to the extent that the lubricating oil leaks from the oil chamber 270 into the stator 230 when the pressure in the oil chamber 270 becomes higher than or equal to the prescribed pressure. Further, the clearance between the inner peripheral surface of the stator 230 and the outer peripheral surface of the piston 260 may be set such that the lubricating oil leaks from the oil chamber 270 into the stator 230 when the pressure in the oil chamber 270 becomes higher than or equal to the prescribed pressure.

The fuel of the internal combustion engine 10 is hydrogen gas, which is a gas fuel, but may be another gas fuel such as compressed natural gas.

The fuel of the internal combustion engine 10 is a gas fuel, but may be a liquid fuel.

The controller 100 is not limited to a device that includes a CPU and a memory and executes software processing. For example, the controller 100 may include a dedicated hardware circuit, such as an application specific integrated circuit (ASIC), that performs hardware processing on at least a part of the software processing in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electromagnetic valve provided in a fuel supply system of an internal combustion engine, the electromagnetic valve comprising an oil chamber from which lubricating oil is supplied to an interior of the electromagnetic valve.

2. The electromagnetic valve according to claim 1, further comprising:
a housing;
a stator,
an electromagnetic coil provided on an outer side of the stator; and
a first valve, wherein the first valve includes:
a plunger that moves in the stator; and
a seal member that opens and closes a fuel passage through movement of the plunger,
the oil chamber is provided in the stator,
the electromagnetic valve further comprises a piston in the stator,
the piston is configured to reduce a volume of the oil chamber through an opening operation of the first valve, and
the piston includes a check valve that allows the lubricating oil to be supplied from the oil chamber into the stator when a pressure in the oil chamber becomes higher than or equal to a prescribed pressure.

3. The electromagnetic valve according to claim 2, wherein
the fuel passage is a first fuel passage,
the seal member is a first seal member,
the electromagnetic valve further comprises:
a second fuel passage that has a cross-sectional flow area larger than that of the first fuel passage, the second fuel passage being connected to the first fuel passage, and opened and closed by a second seal member;
a holder provided in the housing; and
a second valve accommodated to be slidable on an inner peripheral surface of the holder, the second valve including the second seal member, and
the second valve includes a hole on which an outer peripheral surface of the first valve slides.

4. The electromagnetic valve according to claim 1, wherein the electromagnetic valve is applied to a fuel pressure control in which a pressure of fuel is controlled by repeatedly and selectively opening and closing of the electromagnetic valve.

5. The electromagnetic valve according to claim 1, wherein the fuel of the internal combustion engine is a gas fuel.
